(19) United States
(12) Patent Application Publication
(10) Pub. No.: US 2008/0053609 A1
(43) Pub. Date: Mar. 6, 2008

(54) PRESS AND METHOD FOR LAMINATING BOARD-SHAPED WORK PIECES VIA PRESSURE AND HEAT

(75) Inventor: Wolfgang Renz, Freudenstadt (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 11/838,344

(22) Filed: Aug. 14, 2007

(30) Foreign Application Priority Data
Aug. 29, 2006 (EP) 06017945.4

(51) Int. Cl. B29C 65/02; B29C 43/52; B30B 15/34; B30B 7/00; B32B 37/06; B32B 37/10

(52) U.S. Cl. 156/285; 100/325; 100/38; 156/382

(57) ABSTRACT

A press and a method to laminate board-shaped work pieces via pressure and heat is provided. The press includes an upper press table 1 having an upper press plate 7 and a lower press table 2 having a lower press plate 10, and the upper and/or the lower press plate can be heated. The press further includes a one or two-part encircling gasket 16, 17, arranged at the upper press table 1 or the upper press plate 7 and/or the lower press table 2 to form a vacuum pressure chamber when the press is closed, an actuator 4 to open and close the press, as well as a vacuum source connection to evacuate the vacuum chamber formed by the seal 16, 17. According to the invention the lower press plate 10 can be raised in reference to the lower press table 2 and is arranged such that a work piece 6 located in the press initially does not contact the heated press plate 7, 10 when the vacuum pressure chamber is closed. The lamination method according to the invention is therefore embodied in two steps: first the vacuum pressure chamber is evacuated and only then is the work piece hot pressed.

### CROSS-REFERENCE TO RELATED APPLICATIONS

This application claims the benefit of EP 06 017 945.4, filed Aug. 29, 2006, which is incorporated by reference herein as if fully set forth.

### BACKGROUND

The invention relates to a press for laminating board-shaped work pieces via pressure and heat as well as a method for using a laminating press.

A press of this type comprises an upper press table with an upper press plate as well as a lower press table with a lower press plate, and at least one of the two press plates can be heated. An encircling gasket, arranged at the upper press table and/or the upper press plate or arranged at the lower press table forms a vacuum pressure chamber sealed from the outside when the press is closed so that the work piece can be laminated in a vacuum. The encircling gasket can also be provided in two parts and be arranged, on the one hand, at the upper press table and/or the upper press plate as well as, on the other hand, at the lower press table, so that the two parts of the gasket contact when the press is closed. In order to allow the vacuum pressure chamber to be evacuated, means are provided to evacuate the vacuum pressure chamber formed by the gasket.

Presses of his type are primarily used to laminate circuit boards with printed circuits. Here, a board-shaped work piece comprising two copper foils and at least one interior layer made from a fiberglass web saturated with resin, a so-called prepreg, is inserted into the press and laminated through heat application, in order to reach the typical melting temperature of the resin, and pressure. With the pressure being applied the melting resin of the prepreg ensures the close connection of the individual layers of the work piece. Depending on the work piece, typically up to 40 structured interior layers are provided in the prepreg between the two exterior copper foils.

It has shown that the processing time necessary to achieve satisfactory results by such laminating methods can be advantageously shortened when hot pressing occurs in a vacuum. Such a method is known for example from DE 42 32 610 A1. The lamination process described here operates with pressing periods ranging from one to three minutes at a press temperature from 175° to 250° C. and typical pressures ranging from 350 to 1,000 N/cm², while the pressure inside the vacuum pressure chamber amounts to approximately 0.05 bar.

The press described in DE 42 32 610 A1 is provided at its upper press plate with a sealing frame encircling the edge, which contacts the lower press plate when the press is closed and which can be deformed with sufficient elasticity to ensure, on the one hand, sealing the space between the two press plates to form a vacuum pressure chamber and, on the other hand, not to hinder the press motion of the two press plates in reference to each other.

### SUMMARY

The present invention is based on the object to further improve a method and a press of the above-described type with regard to the exact adherence of the process parameters and the process results.

This object is attained in a press having the features of the invention and a method according to the invention.

Further preferred embodiments of the press are described below, along with preferred embodiments of the method.

The primary difference to prior art is therefore according to the invention that first the vacuum pressure chamber is closed and evacuated, without the work piece contacting a heated press plate, and only thereafter, when the vacuum has been created in a defined manner, the work piece is hot pressed. For this purpose the lower press plate is embodied such that it can be raised in reference to the lower press table, namely such that a closing of the press only leads to sealing the vacuum pressure chamber but not to the lower and the upper press plates contacting each other and/or the work piece. Only the raising of the lower press plate, with an already closed press which is possible separately according to the invention, leads to the work piece contacting the two press plates as well the transfer of the processing heat to the work piece and the application of the pressure.

In reference to the known prior art, the measures according to the invention achieve a higher processing safety because a defined sequence of the processing steps of evacuating and hot pressing is provided in a reproducible manner. In the prior art, sometimes the sequence of heating the work piece and evacuating the vacuum pressure chamber occurs randomly. Furthermore, the invention allows the lamination process to be performed with lower pressures and consistently short clock times, achieving an overall better and consistent quality level.

It is particularly advantageous when the lower press plate that can be raised according to the invention is supported floating on the lower press table and in particular is raised via a fluid-impinged pressure chamber between the lower press table and the lower press plate. Through the use of the latter, any potential uneven areas of the work piece as well as tolerances of the press plates, which may be even emphasized by the heating cycle, are automatically compensated.

In order to form the pressure chamber, a valve may be provided which is impinged by a fluid. The pressure chamber may also be formed with a pressure cushion which is known per se.

In order to operate the press according to the invention, in a short interval process it is advantageous for a continuous conveyer belt to travel between the lower and the upper press plates. The work piece can then be transported into the press, resting on the conveyer belt, the press can be closed, evacuated, and the lower press plate be raised, with the work piece still resting on the conveyer belt. After the press is opened, the laminated work piece is then transported out of the press via the conveyer belt. Here it is useful for the work piece to be arranged between two separating metal sheets to prevent the resin from contacting the conveyer belt.

The press is preferably provided with an upper press table that can be raised and lowered, with a piston-cylinder unit ensuring the up and down motion of the upper press table. Simultaneously, the upper press plate can be heated, which particularly facilitates the process for the work piece initially not being brought into contact with the heated press plate when the press is closed and the vacuum pressure chamber is sealed.

In particular when using a continuous conveyer belt, the lower press plate may be heated, though, because the work piece can rest on the conveyer belt when the press is closed and the vacuum pressure chamber is sealed without already contacting the lower press plate.

### BRIEF DESCRIPTION OF THE DRAWINGS

An exemplary embodiment of the press according to the invention is explained and described in greater detail using the attached drawings. Shown are:

FIG. 1 is a lateral cross-sectional view of a press according to the invention;

FIG. 2 is an enlarged view of a section of FIG. 1.

### DETAILED DESCRIPTION OF THE PREFERRED EMBODIMENTS

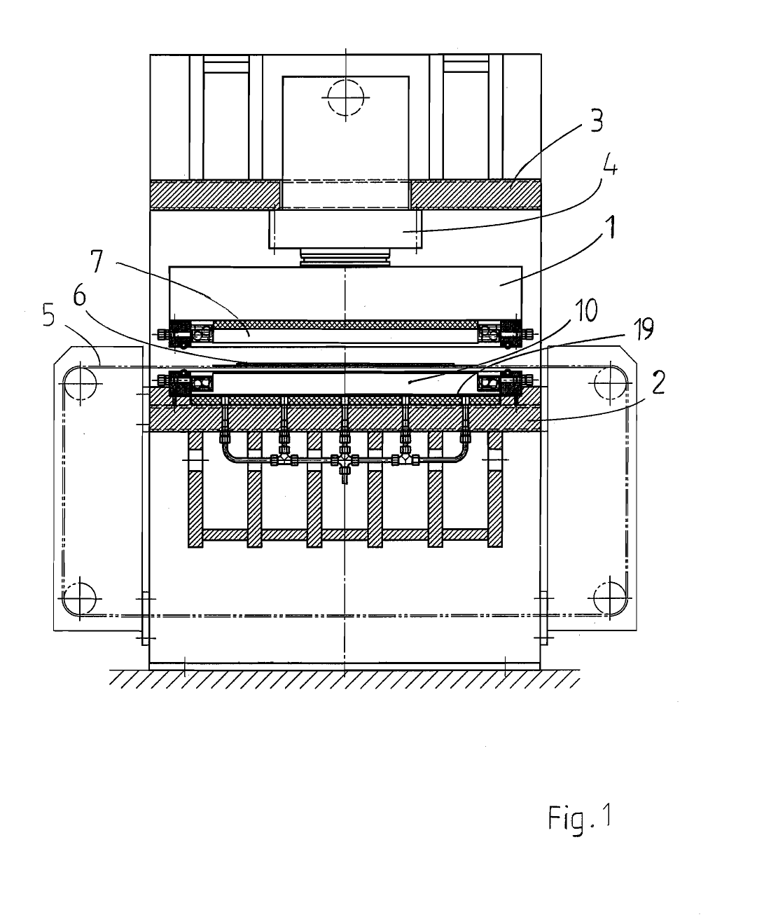

The press shown in FIG. 1 comprises an upper press table 1 and a lower press table 2, with the lower press table 2 being supported locally fixed in a press stand 3. In the press stand 3, a hydraulic piston-cylinder unit 4 is mounted, on which the upper press table 1 is arranged. Through use of the piston-cylinder unit 4, the upper press table 1 can be moved up and down. A conveyer belt 5 travels continuously between the upper and the lower press tables 1, 2 in order to transport a work piece 6 into the press and back out of it. During the pressing process the conveyer belt 5 remains in the press, of course.

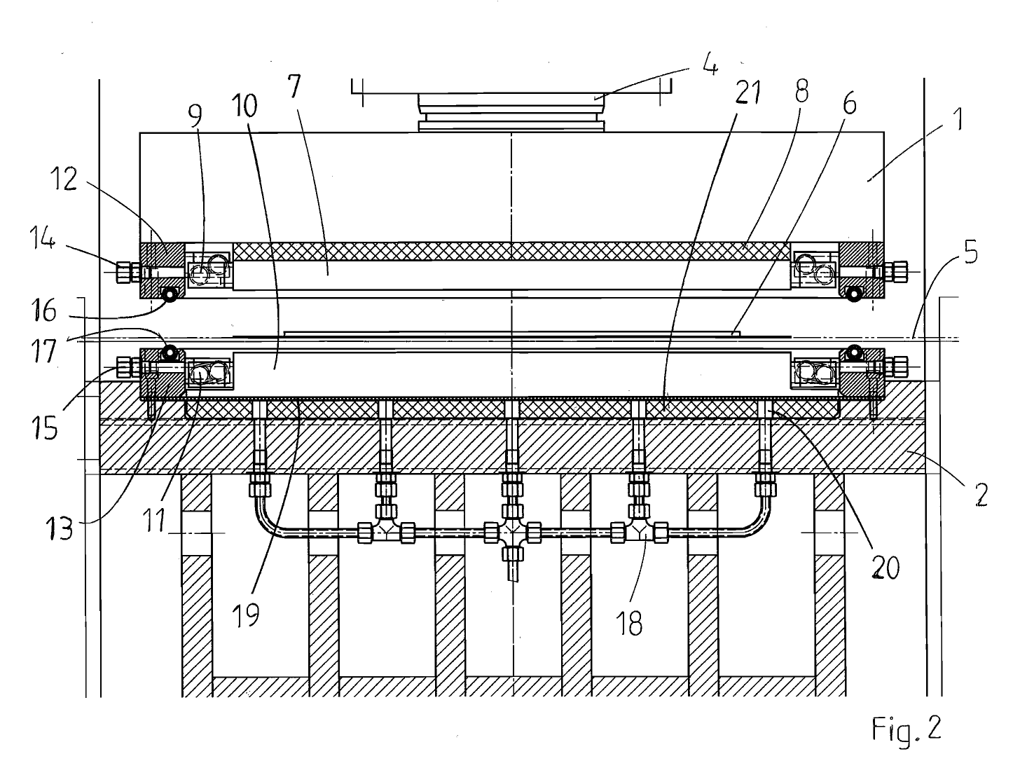

In FIG. 2, which is an enlarged section of FIG. 1, the conditions inside the press are more clearly discernible. The upper press table 1 carries a heated upper press plate 7, which is mounted via an insulating layer 8 to the upper press table 1. Through the use of the flexible connectors 9, a heating fluid is transported, in a manner known per se, into the upper press plate 7, in order for it to consistently maintain the processing temperature. The lower press table 2, in turn, carries a lower press plate 10, which is heated as well and has flexible connectors 11 for a heating fluid.

Both the upper press plate 7 as well as the lower press plate 10 are surrounded by an encircling upper frame 12 and a lower frame 13 mounted in a fixed manner to the respective press table 1, 2, carrying the connecting fixtures 14 and 15 for the connectors 9 and 10 of the heating fluid. Both the upper frame 12, as well as the lower frame 13 each also support a soft-elastic gasket 16 and 17, with the two parts together forming an encircling seal. When closing the press by lowering the upper press table 1, the two gaskets 16 and 17 contact each other and seal the interior of the press, thus in particular the space between the two press plates 7 and 10, with the work piece 6 located therein from the environment in an airtight manner because the gaskets or seals are arranged in an encircling manner. The frames 12 and 13 at the upper press table 1 and/or the lower press table 2 contact each other when the press is closed so that any further movement of the piston-cylinder unit 4 is blocked.

The press shown is provided such that in a closed press, neither the upper press plate 7 nor the lower press plate 10 contact the work piece 6. The work piece rather still rests on the conveyer belt 5 without any direct thermal contact to the heated press plates 7 and 10.

A suction device (not shown) then evacuates via connectors (not shown either) the frame 12 and/or 13 enclosing the interior space, sealed via the gaskets 16 and 17, between the two press plates 7 and 10. The gaskets 16 and 17 then form the edge of a vacuum pressure chamber.

The lower press plate 10 rests floating according to the invention and thus is not mounted at the lower press table 2. Rather it rests on a membrane 19, below which a number of pressurized air vents 20 from a pressurized air supply 18 open, which extend through the lower press table 2. The membrane 19 is in turn decoupled with regard to heat conductivity from the lower press table 2 via a lower insulating layer 21. By activating the pressurized air support 18 the membrane 19 (not shown here) is pressed upwards like a cushion, by which the lower press plate 10 is raised. By this raising, ultimately the work piece 6 is compressed between the lower press plate 10 and the upper press plate 7 and is both impinged with heat as well as with pressure. At this moment the vacuum in the vacuum pressure chamber is already fully developed.

Using the press shown in FIGS. 1 and 2, the two-step laminating process according to the invention is to be realized, in which first a vacuum pressure chamber is closed and evacuated and only then the work piece is impinged with heat and pressure. After the hot pressing, which typically occurs in short intervals ranging from one to three minutes, the press is opened again and the work piece 6 is removed by the conveyer belt 5. Subsequently another compression interval according to the invention can occur using a new work piece.

It is apparent that the press according to the invention is not limited to the exemplary embodiment shown, but that different variations are within the scope of the invention. For example, only the upper press may be heated to allow the work piece to be inserted into the press being in a heat-conducting contact with the lower press plate. The arrangement of the sealing gasket may be made in different ways as well, for example the gasket can be arranged directly at the press plates, and the means for evacuation can be embodied differently.

1. A press for laminating board-shaped work pieces via pressure and heat, comprising an upper press table (1) having an upper press plate (7) and a lower press table (2) having a lower press plate (10), at least one of the upper or the lower press plate (7, 10) is heated, an encircling gasket (16, 17), made with at least one part is arranged on a least one of the upper press table (1), the upper press plate (7), or the lower press table (2) to form a vacuum pressure chamber when the press is closed, a device (4) that opens and closes the press is connected to the upper press table, and a vacuum source is connected to the vacuum pressure chamber formed by the upper and lower press plates and the gasket (16, 17) when the press is in a closed position, the lower press plate (10) is mounted to be movable with respect to the lower press plate (2) so that it can be raised or lowered so that a work piece (6) located in the press is adapted not to initially contact the heated press plate (7, 10) in the vacuum pressure chamber when the press is closed.

2. A press according to claim 1, further comprising a programmable press control that is programmed such that after insertion of a work piece (6) into the press, first the upper (7) and the lower press plate (10) are moved towards each other until the gasket (16, 17) closes the vacuum pressure chamber, then the vacuum source is activated to evacuate the vacuum pressure chamber, and after the evacuation of the vacuum pressure chamber, the lower press plate (10) is raised in reference to the lower press table (2) to bring the work piece (6) in contact with the upper (7) and the lower press plate (10).

3. A press according to claim 1, wherein the lower press plate (10) is supported floating on the lower press table (2).

4. A press according to claim 3, wherein a fluid-impinged pressure chamber is arranged between the lower press table (2) and the lower press plate (10) to raise the lower press plate (10).

5. A press according to claim 4, wherein a membrane (19) is provided to form the pressure chamber.

6. A press according to claim 5, wherein the pressure chamber is formed by a pneumatic cushion.

7. A press according to claim 1, further comprising a continuous conveyer belt (5) arranged to travel between the upper press plate (7) and the lower press plate (10).

8. A press according to claim 1, wherein the device to open and close the press comprise a piston-cylinder unit (4) that raises and lowers the upper press table (1).

9. A method for laminating board-shaped work pieces via pressure and heat, comprising:
inserting a work piece into an open press with an upper press plate and a lower press plate, at least one of which being heated,
closing the press and forming a vacuum pressure chamber between the press plates without the work piece contacting the heated press plate,
evacuating the vacuum pressure chamber,
raising the lower press plate in order for the work piece to contact both the upper as well as the lower press plate, and
impinging the work piece with pressure.

10. A method according to claim 9, wherein the lower press plate is raised via a pressure cushion.

11. A method according to claim 9, wherein the work piece is inserted into the press between the upper and the lower press plate via a traveling conveyer belt.

12. A method according to claim 9, wherein the work pieces are arranged between two separating metal sheets arranged in the press.
